(19) United States
(12) Patent Application Publication
(10) Pub. No.: US 2007/0177871 A1
(43) Pub. Date: Aug. 2, 2007

(54) Method for transmitting a burst using wavelength separation in optical burst switching system

(75) Inventors: Seoung Young Lee, Yuseong-Gu (KR); In Yong Hwang, Yuseong-Gu (KR); Hong Shik Park, Yuseong-Gu (KR)

Correspondence Address: THE WEBB LAW FIRM, P.C., 700 KOPPERS BUILDING, 436 SEVENTH AVENUE, PITTSBURGH, PA, 15219, US

(73) Assignee: Research and Industrial Cooperation Group, Yuseong-Gu (KR)

(21) Appl. No.: 11/409,595

(22) Filed: Apr. 24, 2006

(30) Foreign Application Priority Data
Jan. 27, 2006 (KR) 10-2006-0008848

(51) Int. Cl. H04J 14/00

(52) U.S. Cl. 398/45

(57) ABSTRACT

Provided is a method for transmitting a burst using wavelength separation in an optical burst switching system, in which a plurality of nodes form a mesh network. The method includes the steps of generating, at a current node, a several hop going (SHG) burst arriving at a destination node by way of a plurality of nodes, allocating the generated SHG burst to a dedicated wavelength group to prevent the generated SHG burst from colliding with SHG bursts generated from previous nodes, and delivering the SHG burst to a next node, checking offset times of the SHG bursts generated from the previous nodes and classifying the SHG bursts according to the offset times, and allocating the SHG bursts separated according to the offset times to different wavelength groups and transmitting the SHG bursts to the next node. Using this method, it is possible to solve a problem of unfair competition among bursts according to the number of nodes that the bursts should transit in the optical burst switching system.

### BACKGROUND OF THE INVENTION

1. Field of the Invention

The present invention relates to a method for transmitting a burst in an optical burst switching system, and more particularly, to a method for transmitting a burst using wavelength separation in an optical burst switching system capable of allowing all of several hop going (SHG) bursts generated at previous nodes to fairly compete with one another to occupy a channel by classifying the SHG bursts according to offset times allocated to SHG bursts, allocating the separated SHG bursts to different wavelengths according to the offset times, and transmitting the SHG bursts.

2. Description of the Related Art

In a conventional optical burst switching system, a burst control packet (BCP) is first transmitted when a burst is generated. After a certain time elapses, a data burst, which is a burst for transmitting real data, is transmitted. This time difference is called an offset time.

Such method for transmitting a burst in an optical burst switching system has been designed so that a data burst transmitted to a next node by way of a current node, i.e., a transit burst and a burst originating from the current node, attempt to occupy a channel at the same time, wherein the burst having the longer offset time is more likely to successfully occupy the channel.

That is, the burst has a higher priority when it has a longer offset time and a lower priority when it has a shorter offset time. For example, when bursts having the same priority transit a different number of nodes to arrive at a destination node, the bursts will have different priorities at the intermediate nodes because of their different offset times. In this manner, since bursts originally having the same priority are left with different priorities, they cannot fairly compete with one another to occupy a channel.

### SUMMARY OF THE INVENTION

It is an object of the present invention to provide a method for transmitting a burst using wavelength separation in an optical burst switching system, the method capable of allowing all of several hop going (SHG) bursts generated at previous nodes to fairly compete with one another to occupy a channel by classifying the SHG bursts according to offset times allocated to SHG bursts, allocating the separated SHG bursts to different wavelengths according to the offset times, and transmitting the SHG bursts.

According to an aspect of the present invention, there is provided a method for transmitting a burst using wavelength separation in an optical burst switching system in which a plurality of nodes form a mesh network, the method comprising the steps of: (a) generating, at a current node, a several hop going (SHG) burst arriving at a destination node by way of a plurality of nodes; (b) allocating the generated SHG burst to a dedicated wavelength group to prevent the generated SHG burst from interfering with SHG bursts generated from previous nodes, and delivering the SHG burst to a next node; (c) checking offset times of the SHG bursts from the previous nodes and separating the SHG bursts according to the offset times; and (d) allocating the SHG bursts separated according to the offset times to different wavelength groups and transmitting the SHG bursts to the next node.

In step (b), the SHG bursts which are delivered from the current node to the next node may be separated at the next node according to the offset time.

### BRIEF DESCRIPTION OF THE DRAWINGS

FIG. 1 illustrates an optical burst switching system having a mesh network structure according to an exemplary embodiment of the present invention;

FIG. 2 illustrates a change in an offset time as an optical burst from a source node arrives at a destination node according to an exemplary embodiment of the present invention;

FIG. 3 shows that an offset time differs according to the remaining number of nodes that a burst having the same priority should transit in order to arrive at a destination node; and

FIG. 4 is a flowchart illustrating a method for transmitting a burst using wavelength separation in an optical burst switching system according to an exemplary embodiment of the present invention.

### DETAILED DESCRIPTION OF EXEMPLARY EMBODIMENTS

The present invention will now be described more fully with reference to the accompanying drawings, in which exemplary embodiments of the invention are shown.

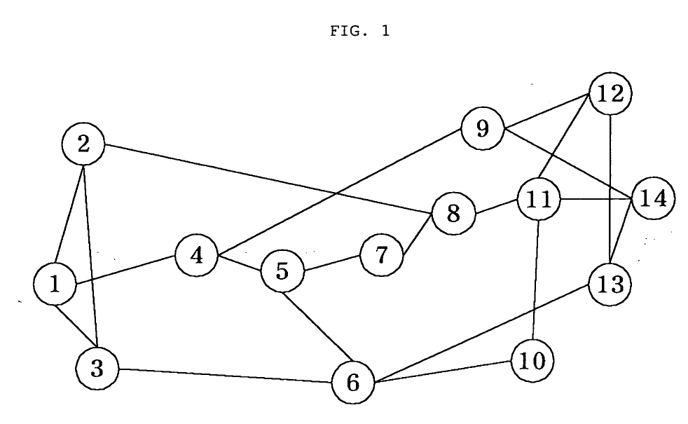

FIG. 1 illustrates an optical burst switching system having a mesh network structure according to an exemplary embodiment of the present invention.

Referring to FIG. 1, in the optical burst switching system having a mesh network structure according to the present invention, each node performs not only a function of generating a burst, but also a function of forwarding bursts generated from previous nodes.

An offset time is allocated to the bursts according to the number of nodes that the burst transits from a source node to a destination node, and a priority of the burst. The priority of the burst is determined according to the offset time.

That is, the burst has a higher priority when it has a longer offset time and a lower priority when it has a shorter offset time. When bursts having the same priority transit a different number of nodes in order to arrive at a destination node, they will have different priorities at the intermediate node.

In this manner, since bursts originally having the same priority are left with different priorities, they cannot fairly compete with one another to occupy a channel. This problem should be solved.

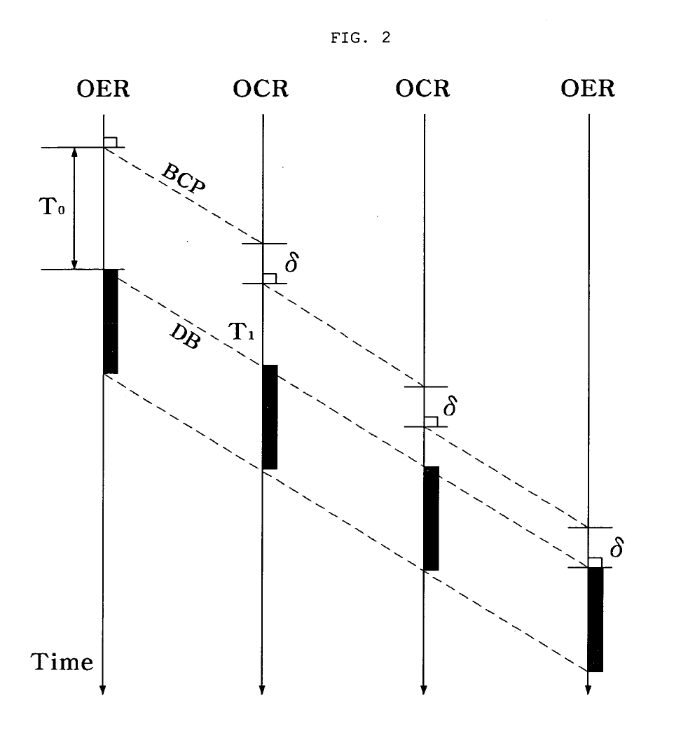

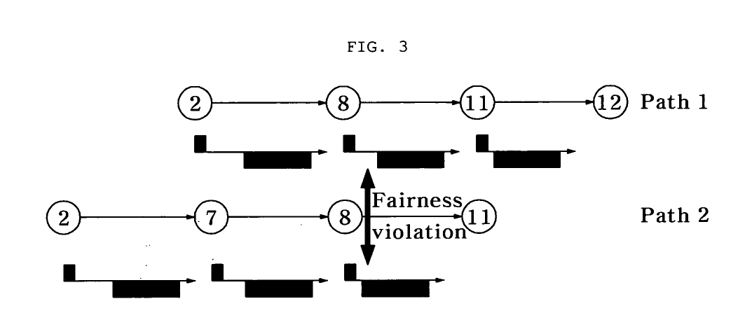

FIG. 2 illustrates a change in an offset time as an optical burst from a source node arrives at a destination node according to an exemplary embodiment of the present invention, and FIG. 3 shows that an offset time differs according to the remaining number of nodes that a burst having the same priority should transit in order to arrive at a destination node.

Referring to FIGS. 2 and 3, a burst control packet (BCP) is subject to optical-to-electrical conversion to establish a path for a data burst DB and to reserve a time for the data burst DB, and then is subjected to electrical-to-optical conversion to be transmitted to the next node. On the other hand, the data burst DB is not subject to the optical-to-electrical and electrical-to-optical conversion and transits all nodes with no processing delay to arrive at a destination node.

For example, in FIG. 2, T₁ indicates an offset time between the burst control packet BCP and the data burst DB at a first node. The burst control packet BCP is transmitted to the next node with a delay of T₁.

In the optical burst switching system that operates according to the principle described above, because only the burst control packet BCP is subject to the optical-to-electrical conversion and signal processing at the intermediate nodes and the data burst DB is not subject to the electrical signal processing, the offset time continuously decreases as the burst transits the intermediate nodes.

Symbols “OER” and “OCR” indicate an optical edge router and an optical core router in the optical burst switching system, respectively.

Further, a symbol “δ” indicates a time taken to establish the path for the data burst DB by performing the optical-to-electrical conversion on the burst control packet BCP to read routing information at the intermediate node.

Meanwhile, FIG. 3 shows that competition fairness among bursts having the same priority is violated as the offset times of the bursts differ depending on the number of remaining nodes.

To solve this problem, the present invention proposes a manner of allocating SHG bursts from previous nodes to a different wavelength according to the offset times and the priorities of the bursts.

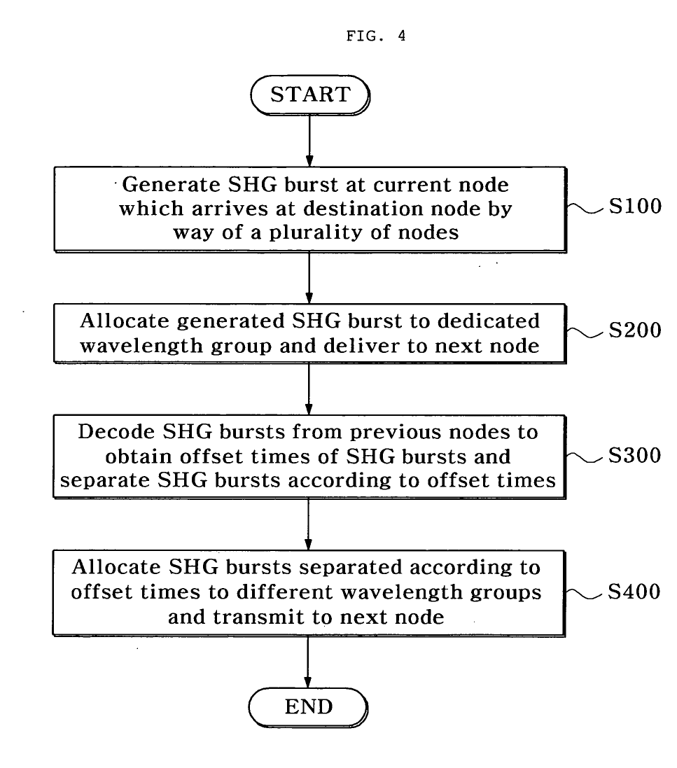

FIG. 4 is a flowchart illustrating a method for transmitting a burst in an optical burst switching system according to an exemplary embodiment of the present invention.

Referring to FIG. 4, a burst which arrives at a destination node by way of a plurality of nodes, i.e., a several hop going (SHG) burst, is first generated at a current node (S100). The generated SHG burst is allocated to a dedicated wavelength group so that the burst does not collide with SHG bursts from previous nodes, and is delivered to a next node (S200).

In this case, since SHG bursts should transit several nodes to arrive at the destination node, offset times of the SHG bursts differ from one another. Thus, a wavelength group for the SHG bursts will be utilized by the bursts having different offset times.

The BCP of SHG bursts generated from the previous nodes are then decoded to obtain their offset times, and separated according to the offset times (S300). The SHG bursts separated according to the offset times are allocated to different wavelength groups and transmitted to the next node (S400).

In this case, the SHG bursts using their dedicated wavelength group are separated according to the offset times after transiting one node. This means that the bursts are separated according to the number of remaining nodes and the priorities allocated to the bursts.

By allocating the separated SHG bursts to wavelength groups according to each offset time as described above, since the offset times of the SHG bursts are the same within any wavelength group, the bursts can fairly compete with one another to occupy the channel.

According to the method for transmitting a burst in an optical burst switching system using wavelength separation of the present invention as described above, it is possible to allow all SHG bursts generated at previous nodes to fairly compete with one another to occupy a channel by separating the SHG bursts according to offset times allocated to SHG bursts, allocating the separated SHG bursts to different wavelengths according to the offset times, and transmitting the SHG bursts.

While the method for transmitting a burst in an optical burst switching system using wavelength separation according to the present invention has been described with reference to exemplary embodiments thereof, it will be understood by those skilled in the art that various changes in form and detail may be made therein without departing from the scope of the present invention as defined by the following claims.

What is claimed is:

1. A method for transmitting a burst using wavelength separation in an optical burst switching system in which a plurality of nodes form a mesh network, the method comprising the steps of:
(a) generating, at a current node, a several hop going (SHG) burst that arrives at a destination node by way of a plurality of nodes;
(b) allocating the generated SHG burst to a dedicated wavelength group to prevent the generated SHG burst from interfering with SHG bursts generated from previous nodes, and delivering the SHG burst to a next node;
(c) checking offset times of the SHG bursts from the previous nodes and separating the SHG bursts according to the offset times; and
(d) allocating the SHG bursts separated according to the offset times to different wavelength groups and transmitting the SHG bursts to the next node.

2. The method according to claim 1, wherein step (b) comprises separating, at the next node, the SHG bursts which are delivered from the current node to the next node according to the offset times.
